(19) United States
(12) Patent Application Publication
(10) Pub. No.: US 2011/0132743 A1
(43) Pub. Date: Jun. 9, 2011

(54) TEXTILE PACKING

(75) Inventors: Alexey SHILKIN, Ludwigshafen (DE); Gunter SCHUCH, Ludwigshafen (DE); Rüediger TÜESHAUS, Dorsten (DE); Peter ROESSLER, Hamm (DE)

(73) Assignees: T & R engineering GmbH, Dorsten (DE); BASF SE, Ludwigshafen (DE)

(21) Appl. No.: 12/898,993

(22) Filed: Oct. 6, 2010

(30) Foreign Application Priority Data
Oct. 7, 2009 (EP) 09012696.2

(51) Int. Cl. B01D 3/00

(52) U.S. Cl. 203/86; 202/267.1

(57) ABSTRACT

There is described a novel woven-fabric packing 1, in which a plurality of woven-fabric layers 2 of metal or plastic filaments 3 are disposed parallel to one another. The woven-fabric layers 2 have protuberances 4, at least one protuberance 4 having an opening 5, which lies in an opening plane 6, which is oriented at an angle of 40 to 140 degrees relative to the woven-fabric layer 2. The openings 5 of woven-fabric layers 2 are all oriented in one opening direction X.

The present invention relates to a woven-fabric packing for thermal substance separation, provided with a plurality of woven-fabric layers of metal and/or plastic filaments, wherein the woven-fabric layers have protuberances, at least one protuberance having an opening, according to the features of the preamble of claim 1.

Furthermore, the invention relates to a method for performing chemical reactions or thermal substance separations in an apparatus according to the preamble of claim 14.

Separating columns are used to perform distillation processes, in which, for example, a liquid and a vapor phase travel in counterflow relative to one another and substance exchange between the two example, distillation or rectification columns. The substance exchange between the liquid and vapor takes place at the interface of the two phases. In order to obtain and maximize this interface, internals having separating effect are mounted in the distillation columns, for example substance-separating plates, disordered filling materials or ordered packings. Among ordered packings there are understood geometric arrangements of shaped sheet or fabric layers, which are disposed in fixed relationship in the substance-exchange apparatus. The packings are characterized by a large specific substance-exchange surface and simultaneously a low pressure loss. Because of the geometry of the packing, the specific substance-exchange surface and the pressure loss of the packing can be selectively modified and adapted to correspond to the desired separation task.

Woven-fabric packings are known from the prior art and are composed of folded or corrugated lamellas of woven-fabric layers, which are soldered or welded at the points of contact. The lamellas may also be screwed or nailed together. These woven-fabric packings are characterized by high separating efficiencies and simultaneously low specific pressure losses. Preferably, woven-fabric packings are used for separating tasks in vacuum and at low liquid loads, for example in the distillation of ethereal oils, of fatty acids or of fatty alcohols. These woven-fabric packings utilize the capillary effect to achieve good wetting of the surface with the feedstocks. In contrast, woven-fabric packings are not used at high liquid loads.

By virtue of the structural design of woven-fabric packings and the associated liquid guidance, the gas load of the packings is limited. An excessive gas load leads to flooding of the packings and thus to failure of the substance-separating apparatus. Capacity of the packing is a phrase used in connection with this situation. A measure of the capacity of a packing, known from the prior art, is the F factor, which is calculated from the gas velocity in the apparatus and the square root of the gas density.

A three-dimensionally formed woven-fabric layer is known from EP 1834693 B1. Therein the woven-fabric packings contain individual woven-fabric layers disposed in parallel. These woven-fabric layers may be made of metal or plastic filaments. Flat materials such as sintered metal fibers may also be used.

The woven-fabric layers are composed of woven wire fabrics, which may be constructed from a wire (monofil) or from a plurality of twisted wires or from fibers (multifil). As far as binding types are concerned, especially the three basic binding types of a woven fabric are used, or in other words linen weave, twill weave and satin weave. However, plain or reverse Dutch weave is also conceivable, and variants of the binding types are also possible. The surface of the woven-fabric layer can be made coarse or fine by the choice of woven-fabric materials as well as by the choice of wires, filaments, mesh width and binding.

EP 1834693 B1 discloses woven-fabric layers held a well-defined distance apart from one another by spacing protuberances. In addition to the spacing protuberances, deflecting protuberances may also be disposed on the woven-fabric layers. The deflecting protuberances differ from the spacing protuberances by the fact that they do not touch the next woven-fabric layer. The deflecting protuberances serve to modify the surface of the woven-fabric layers of the woven-fabric packing. By means of the deflecting protuberances, it is possible on the one hand to modify the specific surface of the woven-fabric packing and on the other hand to achieve selective flow of the liquid phase over the woven-fabric layers of the woven-fabric packing and of the vapor phase along the woven-fabric layers.

From GB 451014 A there are known packings with packing layers that are used in processes for separation or purification of substances. These packing layers preferably have pyramidal protuberances, which are characterized at their upper apices by a circular opening. The openings lie parallel to an alignment plane of the packing layer. Neighboring packing layers rest on one another such that their openings are aligned in complementary manner, thus maintaining a well-defined spacing.

The internals having separating effect, known from the prior art, have the disadvantage that, during use in a vapor-liquid counterflow column, they create flow guidance that is not optimal during the course of the process.

The object of the present invention is therefore to provide a novel woven-fabric packing that permits high capacity of the packing and simultaneously selective flow guidance of the substances to be separated.

The object is achieved according to the invention by the features of claim 1, in that the woven-fabric packing has individual woven-fabric layers, which in turn have protuberances with openings, and in that the openings have an opening plane oriented at an angle of 40 to 140 degrees relative to the woven-fabric layer.

During operation of the inventive woven-fabric packing, this has the particularly advantageous effect that the vapor flow is selectively disturbed by the protuberances between the woven-fabric layers, to the effect that part of the vapor flows through the openings in the protuberances and in this way is effectively distributed in the entire woven-fabric packing. Whirls caused by the disturbance of the vapor flow ensure constant renewal of the laminar film in the vapor phase at the interface between liquid and vapor, whereby a driving concentration gradient exists between the phases and intensive substance exchange is possible.

Preferably the opening planes are disposed at an angle of 60 to 120 degrees, particularly preferably 90 degrees relative to the woven-fabric layer. In a counterflow process, an arrangement with an opening oriented substantially perpendicularly permits particularly good admission of the fluid flowing into the opening.

In a preferred embodiment, a woven-fabric layer has a large number of protuberances, each protuberance having an opening. Selective flow deflection is now possible by like orientation of all openings of a woven-fabric layer. These openings may point in the flow direction of a fluid or in the opposite flow direction.

In a particularly preferred embodiment, the protuberances with openings have shell-type geometry in the form of a spherical quadrant. They may be introduced into the woven-fabric layer by stamping or pressing. Further embodiments, such as hemisphere, triangle, half pyramids, bells, cylinders, half cones, rods or cuboids or any desired combination of the aforesaid geometric embodiments, are possible. Depending on the area of application, substance features and desired flow deflection, a suitable geometry according to the present invention must be used here.

Preferably, each woven-fabric layer has protuberances subdivided into spacing protuberances and deflecting protuberances. Deflecting protuberances are structured so as to have a lower height than the spacing protuberances. The height of the deflecting protuberances is preferably 2 to 60 mm, particularly preferably 2 to 15 mm.

The individual woven-fabric layers are braced against one another via the highest points of the spacing protuberances. In this way the spacing protuberances impose a well-defined distance between the woven-fabric layers. This is preferably between 1 and 100 mm, particularly preferably between 1 and 20 mm.

The individual protuberances have a spacing of preferably 5 to 100 mm, particularly preferably 10 to 50 mm from one another. Once again, the present invention offers the possibility of producing a woven-fabric layer optimally adapted to the process by means of the location and shape as well as the composition of deflecting and spacing protuberances on a woven-fabric layer.

In one embodiment, the deflecting protuberances and/or spacing protuberances may be formed on both sides or in alternation on the woven-fabric layer. Here also the advantage is achieved that selective flow guidance is possible by the side-specific alignment of the protuberances.

The woven-fabric layers preferably have compactions in warp or weft direction in the region between the protuberances. Furthermore, liquid-directing portions formed by at least one liquid filament may be woven into the weft or warp direction. Hereby the advantage is obtained that good liquid distribution due to increased capillary forces is achieved at the compactions in the warp or weft region between the protuberances.

At least one edge side of the woven-fabric layer may have multiple-ply structure, wherein the plies preferably can be produced by doubling over or folding the peripheral regions. Hereby the inventive woven-fabric packing achieves much better self-distributing properties by comparison with the woven-fabric packings available on the market.

In a further preferred alternative embodiment of the woven-fabric packings, the surface of the filaments is coated with ceramic or metal. This in turn offers the possibility of matching the woven-fabric layer selectively to the medium used in the substance-separating process.

Preferably, the inventive woven-fabric layers are structured in monofil and/or multifil form from wire-like or flat filaments, the woven-fabric layers preferably being produced by twill weave, satin weave, linen weave or Dutch weave or in any desired combination of the binding types, and the filaments preferably having a diameter of 0.05 to 1 mm, particularly preferably 0.08 to 0.25 mm. Three-dimensional structure can be imparted particularly advantageously to the woven fabric produced in this way by a pressing or stamping process.

Furthermore, the invention discloses a method for carrying out chemical reactions or thermal substance separations in an apparatus having the features of claim 14. This method utilizes woven-fabric packings according to one or more of claims 1 to 13.

Further advantages, features, properties and aspects of the present invention will become apparent from the description hereinafter of preferred embodiments with reference to the drawings, which are provided solely for easier understanding of the invention and wherein:

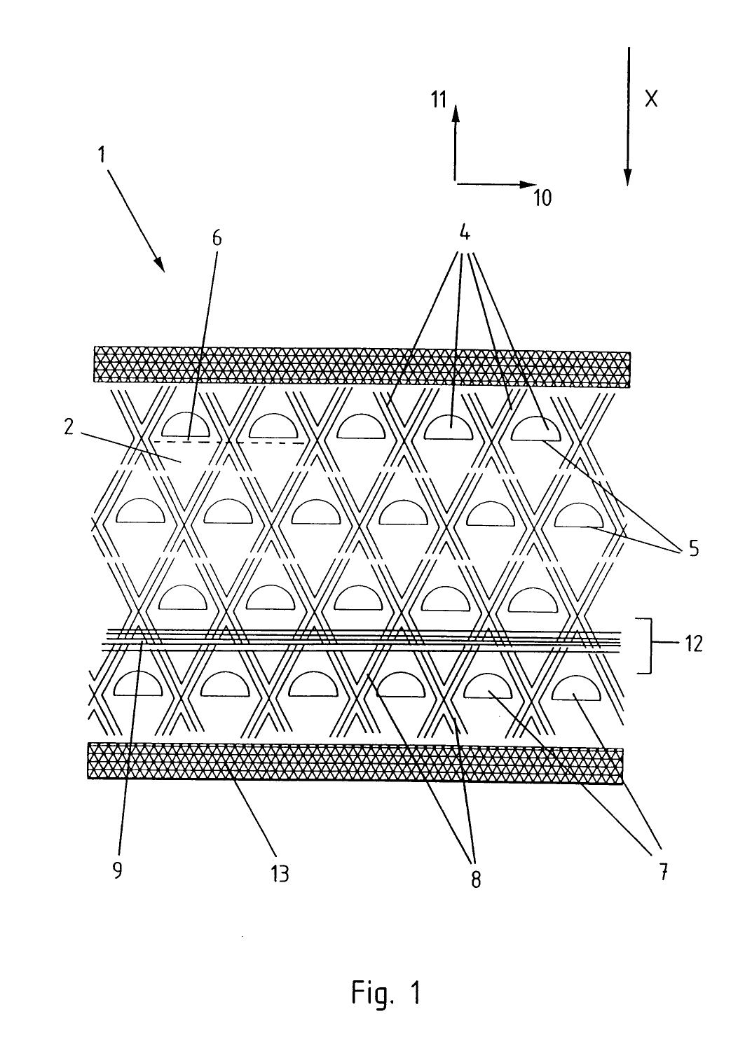

FIG. 1 shows an exemplary patch of a woven-fabric layer;

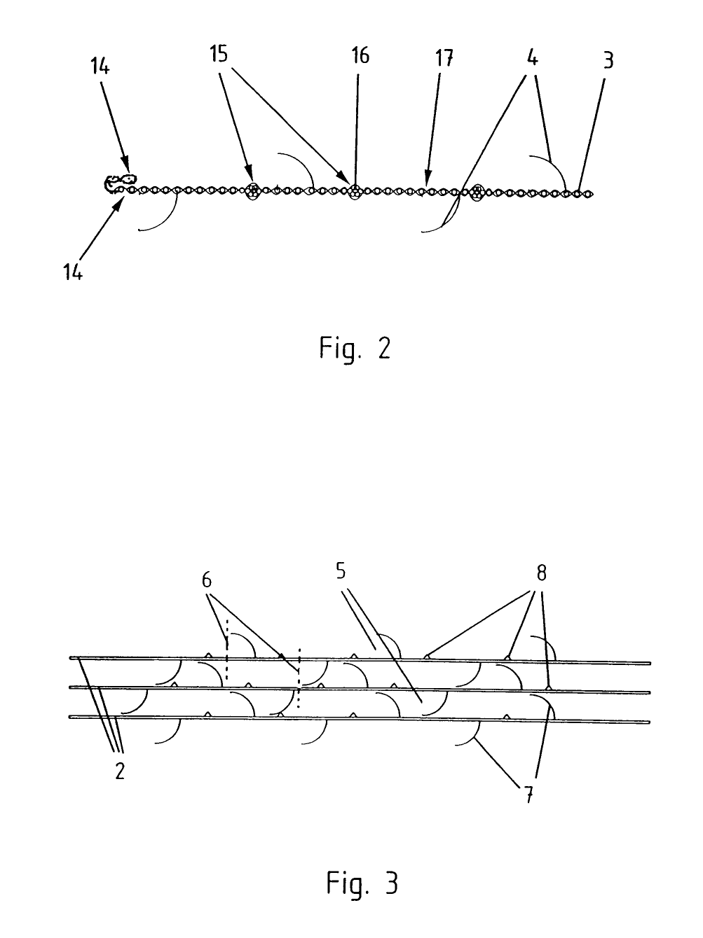

FIG. 2 shows, by way of example, a section through a woven-fabric layer;

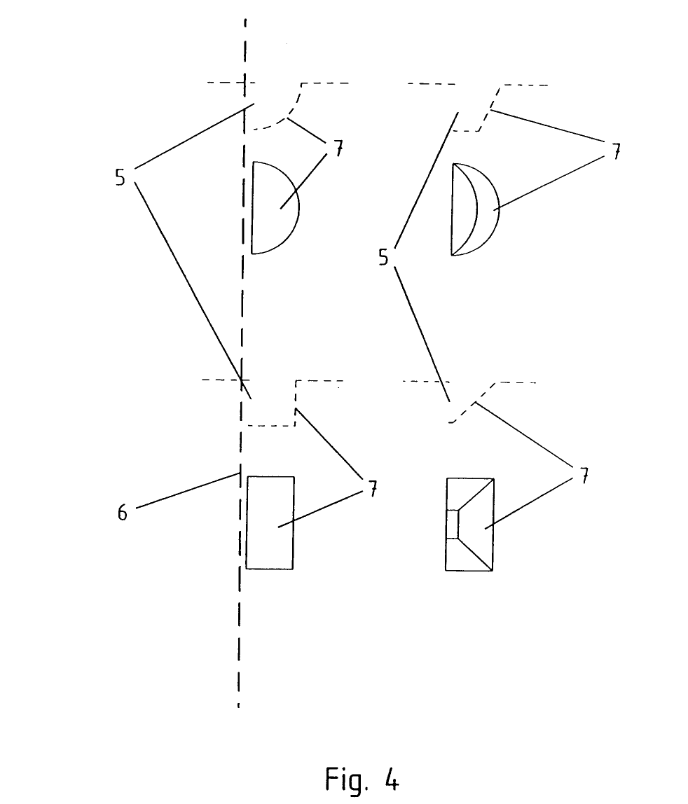

FIG. 3 shows, by way of example, a section through a woven-fabric packing, and;

FIG. 4 shows various embodiments of protuberances.

In the figures, like reference numerals are used for identical or similar parts, corresponding or comparable advantages being achieved even if, for reasons of simplification, the description is not repeated.

FIG. 1 shows a woven-fabric packing 1 in an overhead view, so that only a patch of a woven-fabric layer 2 is visible from above. Woven-fabric layer 2 is woven from filaments 3 in the weaving techniques described in the foregoing, and it is provided with protuberances 4. Protuberances 4 are aligned on woven-fabric layer 2 in accordance with the process in which woven-fabric packing 1 is used. At least one of these protuberances 4 has an opening 5, which is disposed in an opening plane 6. Opening plane 6 is aligned substantially at right angles to woven-fabric layer 2. Openings 5 of all protuberances 4 having an opening 5 are oriented in a direction X.

Protuberances 4 are subdivided into spacing protuberances 7 and deflecting protuberances 8. Spacing protuberances 7 maintain woven-fabric layers 2 spaced apart within woven-fabric packing 1.

Woven-fabric layer 2 has compactions 9, which are formed in warp direction 10 or weft direction 11 on woven-fabric layer 2. Compactions 9 are located in regions 12 between spacing protuberances 7.

FIG. 2 shows a schematic section through a woven-fabric layer 2. On at least one edge side 13, woven-fabric layer 2 has multiple-ply structure. The multiple-ply structure is achieved by doubling over and folding edge side 13. Hereby several plies 14 of woven-fabric layer 2 are formed at edge side 13. Furthermore, liquid-directing portions 15, consisting of at least one liquid-directing filament 16, are incorporated into woven-fabric layer 2. Liquid-directing portions 15 may be woven into woven-fabric layer 2 in warp direction 10 or weft direction 11. Filaments 3 have a surface 17, which may be untreated or may be coated by a metallic or ceramic coating process.

FIG. 3 shows, by way of example, a section through a woven-fabric packing 1, which is formed by a plurality of woven-fabric layers 2. It will be noted that spacing protuberances 7 maintain woven-fabric layers 2 apart from one another. Between spacing protuberances 7, there can be seen deflecting protuberances 8, which have lower height. Spacing protuberances 7 have an opening 5, which is formed substantially perpendicular to woven-fabric layer 2.

FIG. 4 shows, by way of example, four different alternative embodiments of spacing protuberances 7 with openings 5, wherein openings 5 lie in an opening plane 6. Each of the alternative embodiments is shown in a lateral projection and in an overhead view.

### REFERENCE NUMERALS

1—Woven-fabric packing

2—Woven-fabric layer

3—Filament

4—Protuberance

5—Opening

6—Opening plane

7—Spacing protuberances

8—Deflecting protuberances

9—Compaction

10—Warp direction

11—Weft direction

12—Region between two spacing protuberances

13—Edge side

14—Plies

15—Liquid-directing portions

16—Liquid-directing filament

17—Surface of the filaments

X—Direction of the protuberance openings

1. A woven-fabric packing (1) for thermal substance separation, provided with a plurality of woven-fabric layers (2) of metal and/or plastic filaments (3), wherein the woven-fabric layers (2) have protuberances (4), at least one protuberance (4) having an opening (5), characterized in that the opening (5) has an opening plane (6) oriented at an angle of 40 to 140 degrees relative to the woven-fabric layer (2).

2. A woven-fabric packing according to claim 1, characterized in that the opening plane (6) is disposed at an angle of 60 to 120 degrees, preferably 90 degrees relative to the woven-fabric layer (2).

3. A woven-fabric packing according to claim 1 or 2, characterized in that all openings (5) are oriented in the same direction (X).

4. A woven-fabric packing according to one of the preceding claims, characterized in that the protuberances (4) are preferably shell-type structures in the form of a spherical quadrant.

5. A woven-fabric packing according to one of the preceding claims, characterized in that the protuberances (4) are formed by spacing protuberances (7) and/or deflecting protuberances (8), wherein the deflecting protuberances (8) have a lower height than the spacing protuberances (7), preferably 2 to 60 mm, particularly preferably 2 to 15 mm.

6. A woven-fabric packing according to one of the preceding claims, characterized in that the deflecting protuberances (8) and/or spacing protuberances (7) may be formed on both sides or in alternation on the woven-fabric layer (2).

7. A woven-fabric packing according to one of the preceding claims, characterized in that the woven-fabric layers (2) have compactions (9) in warp (10) or weft (11) direction in the region (12) between the spacing protuberances (7).

8. A woven-fabric packing according to one of the preceding claims, characterized in that at least one edge side (13) of the woven-fabric layer (2) has multiple-ply structure, wherein the plies (14) preferably can be produced by doubling over or folding.

9. A woven-fabric packing according to one of the preceding claims, characterized in that liquid-directing portions (15) formed by at least one liquid filament (16) are woven in weft (11) or warp (10) direction.

10. A woven-fabric packing according to one of the preceding claims, characterized in that the surface (17) of the filaments (3) is coated with a ceramic or metal coating.

11. A woven-fabric packing according to one of the preceding claims, characterized in that the woven-fabric layer (2) is structured in monofil and/or multifil form from wire-like or flat filaments (3), the woven-fabric layer (2) preferably being produced by twill weave, satin weave, linen weave or Dutch weave or in any desired combination of the binding types, and the filaments (3) preferably having a diameter of 0.05 to 1 mm, particularly preferably 0.08 to 0.25 mm.

12. A woven-fabric packing according to one of the preceding claims, characterized in that a woven-fabric packing (1) can be disposed at an angle of preferably 30 to 90 degrees, particularly preferably 45 to 90 degrees, relative to an already mounted woven-fabric packing (1).

13. A woven-fabric packing according to one of the preceding claims, characterized in that the protuberances (4) can be formed in the woven-fabric layer (2) by pressing and/or stamping.

14. A method for carrying out chemical reactions or thermal substance separations in an apparatus, characterized in that a woven-fabric packing (1) according to one of claims 1 to 13 is used.

15. A method according to claim 14, characterized in that the woven-fabric layers (2) of the woven-fabric packing (1) are disposed perpendicularly in the apparatus.
